(19) United States
(12) Patent Application Publication
(10) Pub. No.: US 2024/0051545 A1
(43) Pub. Date: Feb. 15, 2024

(54) VEHICLE SENSING WITH BODY COUPLED COMMUNICATION

(71) Applicant: Ford Global Technologies, LLC, Dearborn, MI (US)

(72) Inventors: David Michael Herman, West Bloomfield, MI (US); Yashanshu Jain, Dearborn, MI (US)

(73) Assignee: Ford Global Technologies, LLC, Dearborn, MI (US)

(21) Appl. No.: 17/819,787

(22) Filed: Aug. 15, 2022

(51) Int. Cl. B60W 40/08; B60K 35/00

(52) U.S. Cl. CPC B60W 40/08; B60K 35/00; B60W 2540/225; B60W 2540/229; B60W 2422/00; B60W 2420/42; B60K 2370/736; B60K 2370/569

(57) ABSTRACT

A vehicle can include a body coupled communication (BCC) sensor. A computer in the vehicle can detect that an occupant of a vehicle is touching a screen of a user device, based on a signal from the BCC sensor. Further, it can be determined whether the occupant is in the position of the vehicle operator. Upon determining that the occupant is in the position of the vehicle operator, a gaze direction of the occupant of the vehicle can be determined while the occupant is touching the screen. A prediction can then be output that occupant attention is directed to the screen based on the gaze direction and the signal from the BCC sensor.

### BACKGROUND

Vehicles can operate in various autonomous or semi-autonomous modes in which one or more components such as a propulsion, a brake system, and/or a steering system of the vehicle are controlled by a vehicle computer.

### BRIEF DESCRIPTION OF THE DRAWINGS

FIG. 1 is a block diagram of an example vehicle system.

FIG. 2 shows a simplified block diagram illustrating an example of a Body Coupled Communication (BCC) system in a vehicle.

FIG. 3 illustrates an example BCC pathway.

FIG. 4 is a process flow diagram showing an example process for detecting and compensating for vehicle occupant attention.

### DETAILED DESCRIPTION

A vehicle control system may control vehicle components according to an operator's engagement with a user device such as a portable user device such as a smartphone, a vehicle computer accessible via a display included in a vehicle human-machine interface (HMI), etc. The system can receive data from sensors in a vehicle, and may also receive data from a portable user device in the vehicle concerning whether body coupled communication (BCC) is detected between the operator's body and the user device. This data may be used in conjunction with other data, such as data indicating a gaze direction of the operator. The system can thereby monitor vehicle operator attention, e.g., whether the operator is paying attention to a road as opposed to a user device or a vehicle human-machine interface (HMI). Upon determining operator engagement with the road and/or vehicle operation tasks, or with a user device, a vehicle computer can actuate vehicle components based on the determination.

BCC can cause output from a sensor indicating that a signal has passed through the operator's body to the BCC sensor. The BCC sensor is a capacitive sensor that detects part of a body touching a surface. For example, an occupant of a vehicle may be in contact with a BCC sensor that is included in the vehicle, such as a seat with a capacitive mat embedded therein, or a capacitive sensor mounted on or in a steering wheel, or the like. When the occupant touches another capacitive medium, such as a capacitive touch screen of a user device, a signal can be detected by the vehicle sensor. The occupant's body can act as a signal communication medium (i.e., can provide a path conducting the signal between the user device's capacitive touch screen and the vehicle's capacitive sensor). A vehicle computer can determine from the location of the vehicle sensor receiving the signal whether the occupant touching the user device is seated in the vehicle operator's position and/or has their hands grasping the steering wheel. Further, the computer can receive data from a gaze detection system in the vehicle to determine whether an operator's gaze is in a direction of a user device, as additional input for determining occupant attention. Alternatively or additionally, the computer can estimate or determine occupant attention at least in part by communicating with the user device (e.g., vehicle touchscreen included in a vehicle human machine interface (HMI), portable device such as a smartphone, etc.) to determine a status of the user device. That is, based on an application being executed on the user device, the vehicle computer can determine occupant attention by determining that the occupant was providing input to and/or receiving out from the application on the user device. The state of the device, i.e., one or more applications executing on the device, combined with data from a driver facing camera (DFC)-based driver monitoring system, can predict operator attention, and can support determinations by a vehicle computer concerning vehicle operations.

A system comprises a computer including a processor and a memory, the memory storing instructions executable by the processor to detect that an occupant of a vehicle is touching a screen of a user device, based on a signal from a body coupled communication (BCC) sensor; determine whether the occupant is in a position of a vehicle operator; upon a determination that the occupant is in the position of the vehicle operator, determine a gaze direction of the occupant of the vehicle while the occupant is touching the screen; and predict that occupant attention is directed to the screen based on the gaze direction and the signal from the BCC sensor.

The user device can be a portable device. The BCC sensor can be in a steering wheel or a seat of the vehicle. The memory can store further instructions executable by the processor to determine a type of application executing on the user device. Predicting that occupant attention is directed to the screen can include determining that the occupant gaze direction is one of continuously directed to the road on which the vehicle is traveling, or intermittently directed away from the road. Predicting that occupant attention is directed to the screen can be based at least in part on at least one of: output from a camera; output from a machine learning program; and a type of application determined to be executing on the user device. The memory can store further instructions executable by the processor to output, upon predicting that occupant attention is directed to the screen, a command to control at least one of: the user device; and at least one component of the vehicle. The command can be to the user device to disable an application executing on the user device. The command can be to a component of the vehicle that is one of propulsion, brakes, steering, and a human machine interface (HMI) in the vehicle. The memory can store further instructions executable by the processor to detect that the occupant is touching the screen when not touching a steering wheel of the vehicle. The memory can store further instructions executable by the processor to send a message to the user device for display on the screen. The memory can store further instructions executable by the processor to stop sending the message to the user device.

A method comprises detecting that an occupant of a vehicle is touching a screen of a user device, based on a signal from a body coupled communication (BCC) sensor; determining whether the occupant is in a position of a vehicle operator; upon determining that the occupant is in the position of the vehicle operator, determining a gaze direction of the occupant of the vehicle while the occupant is touching the screen; and predicting that occupant attention is directed to the screen based on the gaze direction and the signal from the BCC sensor. The user device can be a portable device. The BCC sensor can be in a steering wheel or a seat of the vehicle. Predicting that occupant attention is directed to the screen can include determining that the occupant gaze direction can be one of: continuously directed to a road on which the vehicle is traveling; and intermittently directed away from the road on which the vehicle is traveling. Predicting that occupant attention is directed to the screen can be based at least in part on one or more of: output from a camera; output from a machine learning program; and a type of application determined to be executing on the user device. Upon predicting that occupant attention is directed to the screen, at least one of the following can be controlled: the user device, and at least one component of the vehicle; wherein the component is one of propulsion, brakes, steering, or a human machine interface (HMI) in the vehicle. A control command can specify at least one of: to disable an application executing on the user device; or to send a message to the user device for display on the screen. The method can further comprise predicting that the occupant can be touching the screen when not touching a steering wheel of the vehicle.

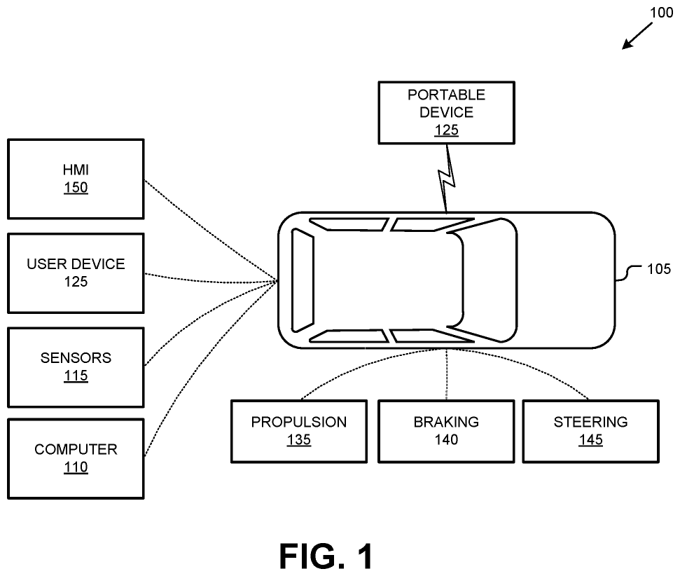

FIG. 1 illustrates an example system 100 for a vehicle 105. A computer 110 in the vehicle 105 is programmed to receive data collected from one or more sensors 115, and other sensors (not shown), to provide certain vehicle data. For example, one or more camera sensors 115 may provide image data from a camera's field of view. A user device with a touch screen may be disposed in vehicle 105. Example user devices include a vehicle computer 110 communicatively coupled (e.g., via a vehicle network) to an HMI 150 with a touch screen installed as part of a vehicle 105 infotainment system, or a hand-held portable computing device 125 with a touch screen. While all modern original equipment manufacturers (OEMs) of passenger vehicles currently warn drivers against using a hand held portable device while driving a vehicle due to safety concerns, it is anticipated that technology and the regulatory framework may evolve in the future to where such an activity becomes safe and permissible.

Vehicle data may further include a location of the vehicle 105, data about an environment around a vehicle, data about an object outside the vehicle such as another vehicle, etc. A vehicle location may be provided in a conventional form, e.g., geo-coordinates such as latitude and longitude coordinates obtained via a navigation system that uses a global navigation satellite system (GNSS) such as the Global Positioning System (GPS) system. Further examples of vehicle data can include measurements of vehicle systems and components, e.g., a vehicle velocity, a level of fuel in a fuel tank, etc.

The computer 110 is generally programmed for communications on a vehicle network, for example, a conventional vehicle communications bus such as a Controller Area Network (CAN) bus, a Local Interconnect Network (LIN) bus, etc., and/or other wired and/or wireless technologies, e.g., Bluetooth, WIFI, Ethernet, etc. Via the network, bus, and/or other wired or wireless mechanisms (e.g., a wired or wireless local area network in the vehicle 105), the computer 110 may transmit messages to various devices in the vehicle 105 and/or receive messages from the various devices, e.g., sensors 115, controllers and actuators (not shown), etc.

Alternatively or additionally, for example, in cases where the computer 110 actually comprises multiple devices, the vehicle network may be used for communications between devices represented as the computer 110 in this disclosure. For example, the computer 110 can be a generic computer with a processor and memory as described above, and/or may include a dedicated electronic circuit including an application specific integrated circuit (ASIC) that is manufactured for a particular operation, e.g., an ASIC for processing sensor data and/or communicating the sensor data. In another example, the computer 110 may include a Field-Programmable Gate Array (FPGA), which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with a network and/or devices outside of the vehicle (not shown), which may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve data stored in the memory via a network in the vehicle 105, e.g., over a CAN bus, a wireless network, etc. Alternatively or additionally, the memory can be part of the computer 110, e.g., as a memory of the computer 110.

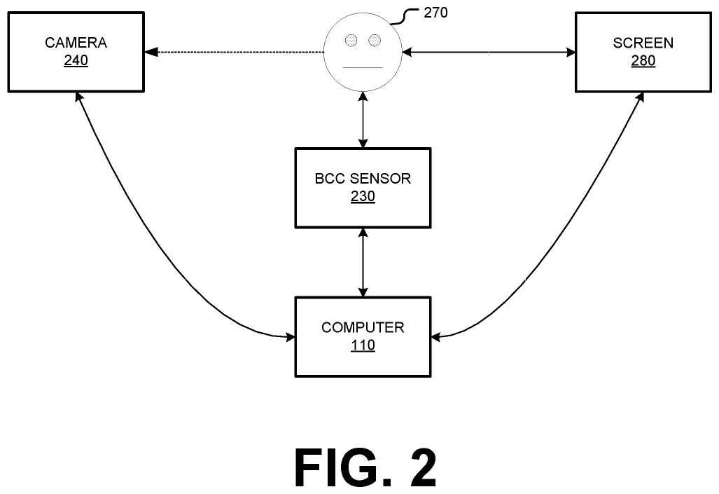

Sensors 115 can include a variety of devices, such as BCC sensors 230 (see FIG. 2). Further for example, various controllers in a vehicle 105 may operate as sensors 115 to provide data via the vehicle network or bus, e.g., data relating to vehicle speed, acceleration, location, subsystem and/or component status, etc. Further, other sensors 115 could include cameras, motion detectors, etc., i.e., sensors 115 may provide data for evaluating a status of a component, evaluating a slope of a roadway, etc. The sensors 115 could, without limitation, also include short range radar, long range radar, light detection and ranging (LIDAR), ultrasonic transducers, and the like. Cameras herein typically are optical cameras, e.g., in the visible spectrum, but could alternatively or additionally include other kinds of cameras, e.g., time-of-flight, infrared, etc.

Collected data can include a variety of data collected in a vehicle 105. Examples of collected data are provided above. Data are generally collected using one or more sensors 115, and may additionally include data calculated therefrom in the computer 110. In general, collected data may include any data gathered by the sensors 115 and/or computed from such data.

The vehicle 105 can include a plurality of vehicle components. In this context, a vehicle component may include one or more hardware components adapted to perform a mechanical function or operation—such as moving the vehicle 105, slowing or stopping the vehicle 105, steering the vehicle 105, etc. Non-limiting examples of components include a propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices, e.g., electronic control units (ECUs) or the like and/or computing devices such as described above with respect to the computer 110, and that likewise communicate via a vehicle network.

A vehicle 105 can operate in one of a fully autonomous mode, a semiautonomous mode, or a non-autonomous mode. A fully autonomous mode is defined as one in which each of vehicle propulsion 135 (typically via a powertrain including an electric motor and/or internal combustion engine), braking 140, and steering are controlled by the computer 110, i.e., in “autonomous operation.” A semi-autonomous mode is one in which at least one of vehicle propulsion (typically via a powertrain including an electric motor and/or internal combustion engine), braking, and steering are controlled at least partly by the computer 110 in autonomous operation as opposed to a human operator in “manual” control. In a non-autonomous mode, i.e., a manual mode, the vehicle propulsion 135, braking 140, and steering 145 are controlled by a human operator.

System 100 is shown comprising vehicle 105 which may include Advanced Driver Assistance System (ADAS) features. A computer 110 (e.g., one or more vehicle 105 ECUs) can be configured to operate the vehicle 105 independently of operation by an occupant with regard to certain features. The computer 110 may be programmed to operate a propulsion system 135, a braking system 140, a steering system 145, a device screen that displays a Human Machine Interface (HMI) 150, and/or other vehicle systems.

The HMI 150 typically includes one or more of a display, a touchscreen display, a microphone, a speaker, etc. The user can provide input to devices such as the computer 110 via the HMI 150. The HMI 150 can communicate with the computer 110 via the vehicle network, e.g., the HMI 150 can send a message including the user input provided via a touchscreen, microphone, a camera that captures a gesture, etc., to a computer 110, and/or can display output, e.g., via a screen, speaker, etc.

FIG. 2 shows a simplified block diagram illustrating an example of a Body Coupled Communication System 200 in a vehicle. The computer 110 is a microprocessor-based computer including at least a processor and a memory. The memory stores instructions executable by the processor. Such instructions constitute computer programs or program modules that can be programmed to operate as described herein. The memory may also comprise a data storage device that stores digital data. In some examples, the computer 110 may include individual or multiple computers networked together.

The computer 110 may transmit and/or receive data or message packets as signals through a communications network in a vehicle such as a controller area network (CAN) bus, Ethernet, WiFi, Local Interconnect Network (LIN), onboard diagnostics connector (OBD—II), and/or by any other wired or wireless communications network. For example, the computer 110 may communicate with components of the propulsion system 135; the braking system 140; the steering system 145, the HMI 150, and/or other components. In addition as shown in FIG. 2, computer 110 may also communicate with one or more sensors 115 such as one or more BCC sensors 230 and cameras 240, and may generate data such as signals or messages based on sensor 115 (e.g., BCC sensor 230 and/or cameras 240) data, and send them over a vehicle network, and may receive signals and/or messages as well.

As seen in FIG. 2, computer 110 can receive inputs and generate signals and/or messages. The inputs can include at least a signal (i.e., one or more data) received from a BCC sensor 230. The BCC sensor 230 can generate a signal when an occupant 270 touches a medium of capacitance, such as user device touchscreen 280. A capacitive touch screen 280 is a user device display that uses the conductive touch of a user's body, e.g., of a finger, for input. A capacitive touchscreen is coated with a material that can store electrical charges. A user device can determine the location of a touch to the screen by a human body part by the screen's change in capacitance in that location. Further, when the user touches the screen, a small amount of the screen's stored electrical charge can be drawn into the user's finger, resulting in a change in the electrostatic field of the user's body, yielding an output electrical signal which can be detected by the BCC sensor 230. Thus, the occupant's body is a medium that conveys an electrical signal from the capacitive touch screen 280 to the BCC sensor 230. Responsive thereto, the BCC sensor 230 can send a signal to the computer 110, indicating to the computer that the occupant 270 is touching the screen 280 of a user device, e.g., a screen of an HMI 150 in communication with a vehicle computer 150, or a screen of a portable device 125.

A BCC sensor 230 may be any suitable type of sensor that detects changes in an electric field caused by proximity to human skin, such as a surface capacitive sensor, a projected capacitive touch sensor such as a mutual capacitive sensor, a self-capacitive sensor, or the like. BCC sensors 230 may include one or more of a capacitive sensor disposed on or in the steering wheel of the vehicle in one or more of the vehicle seats, such as in a mat built into the seats, and/or in a touchscreen of a display device such as a screen of the vehicle HMI 150. In general, BCC sensors 230 may be sensors that are known be provided in a vehicle 105 for operations such as detecting a user's hands on a steering wheel, detecting a user in a seat, and/or detecting a user's contact with a touchscreen. If one or more BCC sensors 230 are mounted on or in the steering wheel, they may be positioned to detect a hand of an occupant gripping the steering wheel.

One or more cameras 240 may be provided in a passenger cabin of the vehicle 105. For example, a camera 240 may be mounted so that it has a field of view encompassing the vehicle operator's head 270 (as indicated by the dotted arrow in FIG. 2), typically including the operator's face, and may have a resolution sufficient to detect a gaze direction of the operator's eyes. The camera 240 detects visual images and provides the images to the computer 110 for analysis. The camera may provide images periodically, such as one per second, or in a video stream of images, or provide a stream of pixel events determined based upon an intensity change per each pixel. Any suitable technique for determining a direction of an operator's gaze, such as corneal reflection-based methods, computer vision, both classical and machine learning approaches, e.g., a machine learning program including a neural network, etc., can be used when gaze direction is referenced herein.

The occupant 270 can sit in the position of the operator of the vehicle 105 (e.g., typically on the left-hand side of the front row of seats in a vehicle in the United States). As the occupant operates the vehicle 105, the occupant can look through a windshield to view a roadway ahead. When the occupant looks away from the roadway for more than a predetermined amount of time, the computer 110 can generate a message for display to the occupant, and/or can send a control command to one or more components of the vehicle 105 to control the component(s)′ operation. For example, in occupant's gaze direction can be monitored and determined to determine whether an occupant has looked away from a roadway for more than the predetermined amount of time. Further, as described herein, alternatively or additionally to making a determination that an occupant is not looking at a roadway based on gaze direction, the system 200 can determine that an occupant is not looking at a roadway based on a signal from a BCC sensor 230.

Typically, when the occupant looks at the roadway ahead, the occupant can view conditions in the environment, such as objects in the roadway, that may influence how the occupant 270 operates the vehicle 105. For example, the occupant 270 may see a vehicle near and/or approaching the vehicle 105, and the occupant may actuate a brake and/or rotate a steering wheel if warranted. In some circumstances, the operator may look away from the road ahead to operate the vehicle 105. For example, the occupant may look at a rearview mirror to see objects behind the vehicle 105. Likewise, the occupant may view an instrument panel and/or HMI 150 that displays data about vehicle 105 components and operation. For example, the instrument panel typically displays at least a current speed of the vehicle 105, and an amount of fuel in a fuel tank of the vehicle 105. Similarly, the occupant 270 may look at climate controls in a center console to adjust a temperature of the interior of the vehicle 105. In another example, a head unit can include an entertainment subsystem that the occupant can provide input to, e.g., to select a source of music to listen to, or to adjust a volume of a speaker. The occupant may also look out of side windows to see laterally relative to a forward direction of the vehicle 105.

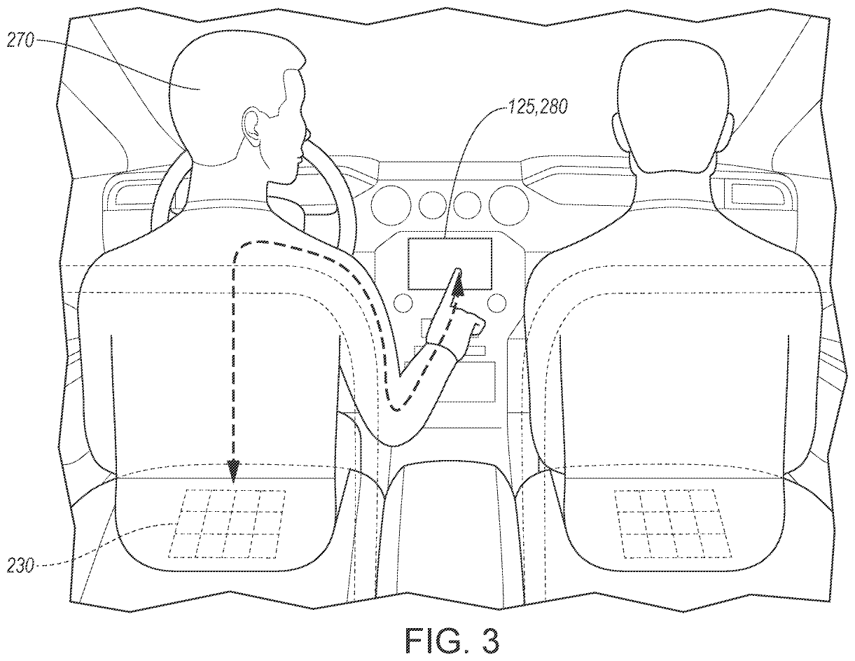

FIG. 3 illustrates an example BCC pathway. In FIG. 3, a vehicle occupant 270 is using an HMI 150 display screen to select a feature presented on the user device screen 280. In another example, a screen 270 could be a screen of a portable device 125. The HMI 150 includes one or more of a display, a touchscreen display, a microphone, a speaker, etc. The user can provide input to devices such as the computer 110 via the HMI 150. The occupant 270 may make a selection by tapping options presented on the screen 280, for example, or by providing a verbal response picked up by a microphone in the vehicle, etc. As shown, a seat mat comprising one or more BCC sensors 230s can be disposed in or on the occupant's seat. As before, when the occupant 270 is in contact with the user device screen 280, charge carriers are exchanged between the user's body and the user device's capacitive touch screen 280. As a result, the electric charge on the body of the occupant 270 changes. As the level of charge in the body of the occupant 270 changes, an electric field generated by the charge carriers changes strength. The change in field strength is detected by a BCC sensor 230 in or on the seat, under the user. Thus, an electric signal is detected by the BCC sensor 230 caused by the occupant 270 touching the screen 280. The signal is propagated across or through the user's body, represented by the dashed line in the figure.

The computer 110 can identify a direction of the gaze of the occupant in the position of the vehicle operator. The “gaze” of the occupant can be defined using a suitable technique such as by a line, a vector, or a cone of confidence along which the occupant's eyes are directed, e.g., toward the road ahead. The computer 110 can use a suitable gaze detection system with the system 200 to augment or complement communicating with a user device, e.g., a computer 110 or portable device 125, to determine its state or status, i.e., what application(s) it is executing. (For example, applicable techniques are discussed in Anuradha Kar and Peter Corcoran, “A Review and Analysis of Eye-Gaze Estimation Systems, Algorithms and Performance Evaluation Methods in Consumer Platforms,” IEEE, 2017, available at the time of filing at https://arxiv.org/ftp/arxiv/papers/1708/1708.01817.pdf; see also Muhammad Qasim Khan and Sukhan Lee, “Gaze and Eye Tracking: Techniques and Applications in ADAS,” National Library of Medicine, December 2019, available at the time of filing at https://www.ncbi.nlm.nih.gov/pmc/articles/PMC6960643/.) In an example, a screen 280 could be displaying data such as a map with a route indicated to a destination specified by the occupant 270 before the trip began. The effect on the occupant's gaze direction(s) in these examples could vary, e.g., from looking at the road ahead with intermittent glances at the screen 280. Depending on the placement of the screen 280, a gaze direction of an occupant 270 may be indistinguishable in these various examples based on an analysis of image data from a camera 240. That is, a same gaze direction could be determined for an occupant looking at a screen 280 mounted on or in a vehicle 105 dash as would be determined for an occupant looking at a road. Further, a user device touchscreen 280, could be positioned outside a field of view of the camera 240. In such cases, a gaze direction determination may lead to a prediction that the occupant's attention is on the road even when it is not. Advantageously, the computer 110 as described herein can receive, in addition to conventional gaze direction data based on image analysis, data about a state of a user device such as a portable device 125 whose screen 280, as indicated by BCC sensor 230 data, is being contacted by the occupant, to thereby predict occupant attention. It will be understood that a gaze line representing gaze direction may be referenced to (e.g., a determination can be made whether the line intersects) vehicle geometry such as a representation of the vehicle HMI 150 display or the front windshield of the vehicle 105. Exterior sensors 115 could be used to identify road features toward which the driver's gaze is directed. Further, a vehicle geometry model for gaze detection could be updated based on signals from the BCC sensor 230 determined to correlate to a gaze direction, e.g., an eye gaze line could be determined to correlate to a signal from a sensor 230 in screen of a portable user device 125, e.g., when vehicle operators enter command on the device 125 screen they tend to look at a specific location. For example, a specific location on the front windshield that may typically be associated with a forward looking gaze in a direction of a road may be updated to be classified as a gaze at the user's device 125.

The computer 110, upon determining or predicting that the occupant 270 attention is not directed to the road of travel and/or a vehicle operating task, can additionally or alternatively generate and send a message where data in the message includes a command to one or more vehicle components. The command may cause a portable device 125 to display a message on its screen 280, and/or can provide a message for display on a screen 280 of the vehicle HMI 150. Other types of communication may be provided by the computer 110 to the occupant 270, such as an audio message by a speaker, or haptic feedback by a vibrating element disposed in the steering wheel or in a seat, or the like. Alternatively or in addition, the data in a message may be a command to control one or more components of the vehicle 105. For example, a command message could be provided to braking 140 to slow the vehicle, and/or or a command to the steering 145 to prevent the vehicle from drifting from or in the lane in the road it is traveling on. At a later time, when the computer 110 determines when the occupant's eyes are most likely back on the road ahead, the computer 110 may stop display of the message, and/or may cease control of one or more vehicle components, e.g., by sending commands as just described, e.g., to enable or disable one or more vehicle features.

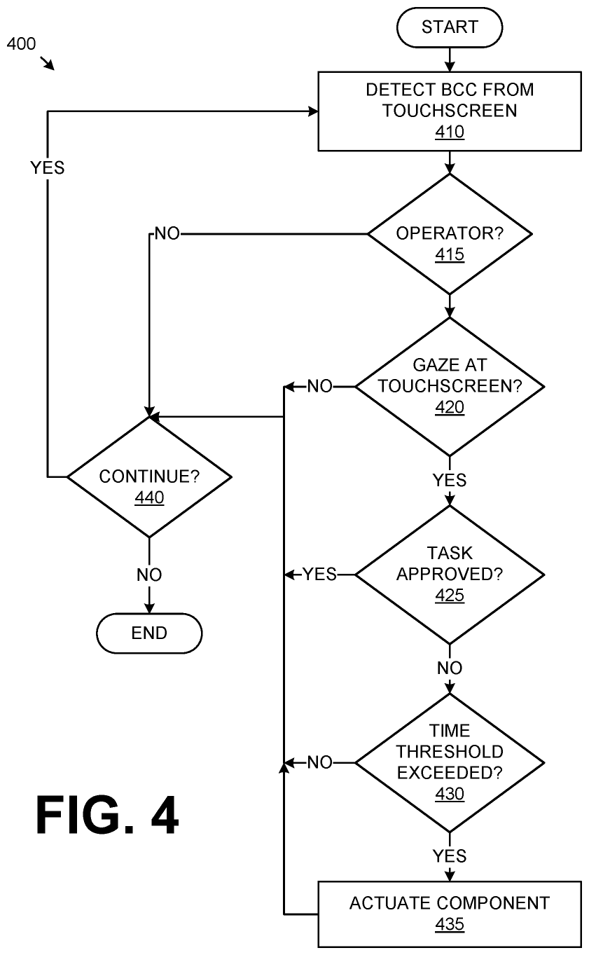

FIG. 4 is a diagram of an example process 400 for predicting vehicle operator attention. The process 400 begins at block 410 in which the BCC system 200 is active in a vehicle 105, e.g., the system 200 may be activated as part of an ignition ON event. In the block 410, a BCC sensor 230 detects a signal indicating an occupant 270 of a vehicle 105 is touching a screen 280 of a user device. The computer 110 can receive a message indicating that the occupant 270 is touching the screen 280 via a vehicle network.

Next, in a block 415, based on the location of the BCC sensor 230, the computer 110 determines whether the occupant touching the screen 280 is in the position of the operator of the vehicle. If not, the process 400 proceeds to a block 440. If the occupant 270 touching the user device screen 280 is in the operator position, then following the block 415, a block 420 is executed next.

In the block 420, the occupant's gaze direction is predicted, e.g., using a suitable technique for analyzing one or more images captured by a camera 240 that is positioned in the vehicle 105 so as to capture images of the face of an occupant 270 in the vehicle operator's position. For example, a gaze detection system may output a gaze direction with respect to a coordinate system in the vehicle and/or a coordinate system extending outside the vehicle, e.g., indicating a point outside the vehicle at which the operator is gazing. The computer 110 could store coordinates of the touchscreen or touchscreens 280 in the vehicle 105. If a direction of an operator's gaze is in a direction of coordinates of the touchscreen or touchscreens, then the determination of the block 420 can be affirmative, whereupon the process 400 proceeds to a block 425. If the operator is not gazing at the touchscreen, then the determination of the block 420 can be negative, whereupon the process 400 proceeds to the block 440. Note that, independent of the BCC system 200, a vehicle 105 could include a gaze detection system to determine that an operator is not gazing at or giving attention to a road, i.e., an operator may not be gazing at a road even if the operator is not gazing at a touchscreen 280.

In the block 425, the computer 110 determines whether the user device (e.g., a portable device 125) associated with the touchscreen 280 at which the operator is gazing is engaged in an approved task. An approved task means that a task, function, or application that the operator is permitted to carry out on the user device, at least not exceeding a threshold amount of time as described with respect to the block 430. For example, the computer 110 could store, e.g., in a lookup table or the like, a set of approved tasks, such as adjusting a vehicle 105 climate control system, adjusting a volume or station setting of an infotainment system, etc. The vehicle computer 110 can determine a task, application, or function executing on the user device by querying the user device via networking and/or communication protocols such as discussed above. For example, a vehicle infotainment system could provide data via a vehicle communication network indicating tasks or functions being carried out by the infotainment system. Similarly, the vehicle computer 110 could query a portable user device 125 such as a smart phone, e.g., via Bluetooth or the like. As illustrated in FIG. 4, if the operator is engaged in an approved task, then the process 400 may proceed to the block 440. Alternatively, the block 430 could always follow the block 425 to determine whether, even for an approved task, a permitted time threshold has been exceeded. Yet further alternatively, if the block 425 is omitted, i.e., the process 400 could check a time threshold without regard to a task executing on the user device.

In the block 430, the computer 110 determines whether a permissible time threshold for user engagement with a user device touchscreen 280 has been exceeded. In some examples, the block 430 could be omitted, i.e., user engagement with a touchscreen 280 may not be permitted regardless of a task or function being executed on the user device. Further, a time threshold for user engagement could depend on a specific task, application, or function being executed on the user device. For example, a permitted time threshold for a messaging or email application could be zero, whereas a permitted time threshold for adjusting a temperature setting of a climate control system could be greater than zero. Yet further, as mentioned above, a time threshold could be the same for any engagement with a touchscreen 280; for example, this would be the case if, as discussed above, the block 425 were omitted. If the time threshold is not exceeded, then the process 400 proceeds to the block 440. If the time threshold is exceeded, then the process 400 proceeds to a block 435.

Next, in the block 435, the computer 400 actuates a vehicle component, i.e., by sending a message or command via a vehicle network. For example, the computer 110 may actuate a component of the vehicle 105, such as propulsion 135, braking 140, steering 145, HMI 150, or the like. For example, the computer 110 could provide one or more commands to actuate and output in a vehicle HMI 150, such as actuating a haptic output device in a seat or steering wheel and/or provide a visual or audio message prompting the operator to return or maintain attention on a road. Further alternatively or additionally, the computer 110 could provide one or more commands to actuate propulsion 135, braking 140, and/or steering 145, e.g., to maneuver a vehicle 105 to a safe stopping position, to control vehicle speed and/or steering based on an operator's lack of attention, etc. Yet further, the actuation of vehicle components could depend on evaluating operator attention over multiple time thresholds. For example, if a first time threshold is exceeded in block 430, the computer 110 could actuate a first component, e.g., an HMI 150 could provide output concerning the operator's lack of attention. Then, if a second time threshold is exceeded, e.g., when the block 430 is encountered a second time, the computer could actuate one or more second components, e.g., propulsion 135, braking 140, and/or steering 145 as just described.

In the block 440, which can follow any of the blocks 415, 420, 425, 430, 435, the computer 110 determines whether to continue the process 400. For example, the computer 110 could be programmed to carry out the process 400 only when a vehicle has a speed greater than zero and/or a vehicle gear selection is not in a “Park” position. If the computer 110 determines to continue, process 400 returns to the block 410. Otherwise, the process 400 ends.

The computing devices discussed herein, including computer 110, include processors and memories. The memories generally including instructions executable by one or more of the computing devices' processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby causing one or more actions and/or processes to occur, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory.

Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system comprising a computer including a processor and a memory, the memory storing instructions executable by the processor to:
detect that an occupant of a vehicle is touching a screen of a user device, based on a signal from a body coupled communication (BCC) sensor;
determine whether the occupant is in a position of a vehicle operator;
upon a determination that the occupant is in the position of the vehicle operator, determine a gaze direction of the occupant of the vehicle while the occupant is touching the screen; and
predict that occupant attention is directed to the screen based on the gaze direction and the signal from the BCC sensor.

2. The system of claim 1, wherein the user device is a portable device.

3. The system of claim 1, wherein the BCC sensor is in a steering wheel or a seat of the vehicle.

4. The system of claim 1, the memory storing further instructions executable by the processor to determine a type of application executing on the user device.

5. The system of claim 1, wherein predicting that occupant attention is directed to the screen includes determining that the occupant gaze direction is one of continuously directed to a road on which the vehicle is traveling, or intermittently directed away from the road.

6. The system of claim 1, wherein predicting that occupant attention is directed to the screen is based at least in part on at least one of:
output from a camera;
output from a machine learning program; and
a type of application determined to be executing on the user device.

7. The system of claim 1, the memory storing further instructions executable by the processor to output, upon predicting that occupant attention is directed to the screen, a command to control at least one of:
the user device; and
at least one component of the vehicle.

8. The system of claim 7, wherein the command is to the user device to disable an application executing on the user device.

9. The system of claim 7, wherein the command is to a component of the vehicle that is one of propulsion, brakes, steering, and a human machine interface (HMI) in the vehicle.

10. The system of claim 1, the memory storing further instructions executable by the processor to detect that the occupant is touching the screen when not touching a steering wheel of the vehicle.

11. The system of claim 1, the memory storing further instructions executable by the processor to send a message to the user device for display on the screen.

12. The system of claim 11, the memory storing further instructions executable by the processor to stop sending the message to the user device.

13. A method comprising:
detecting that an occupant of a vehicle is touching a screen of a user device, based on a signal from a body coupled communication (BCC) sensor;
determining whether the occupant is in a position of a vehicle operator;
upon determining that the occupant is in the position of the vehicle operator, determining a gaze direction of the occupant of the vehicle while the occupant is touching the screen; and
predicting that occupant attention is directed to the screen based on the gaze direction and the signal from the BCC sensor.

14. The method of claim 13, wherein the user device is a portable device.

15. The method of claim 13, wherein the BCC sensor is in a steering wheel or seat of the vehicle.

16. The method of claim 13, wherein predicting that occupant attention is directed to the screen includes determining that the occupant gaze direction is one of:
continuously directed to a road on which the vehicle is traveling; and
intermittently directed away from the road on which the vehicle is traveling.

17. The method of claim 13, wherein predicting that occupant attention is directed to the screen is based at least in part on one or more of:
output from a camera;
output from a machine learning program; and
a type of application determined to be executing on the user device.

18. The method of claim 13, further comprising, upon predicting that occupant attention is directed to the screen, controlling at least one of:
the user device, and
at least one component of the vehicle;
wherein the component is one of propulsion, brakes, steering, or a human machine interface (HMI) in the vehicle.

19. The method of claim 18, wherein a control command specifies at least one of:
to disable an application executing on the user device; or
to send a message to the user device for display on the screen.

20. The method of claim 13, further comprising predicting that the occupant is touching the screen when not touching a steering wheel of the vehicle.
